(19) United States
(12) Patent Application Publication
(10) Pub. No.: US 2014/0169496 A1
(43) Pub. Date: Jun. 19, 2014

(54) Crest Factor Reduction for Multi-Band System

(71) Applicant: Texas Instruments Incorporated, Dallas, TX (US)

(72) Inventors: Zigang Yang, Plano, TX (US); Lars Jorgensen, Royal Oaks, CA (US); Hardik Gandhi, Mountain View, CA (US); Lei Ding, Plano, TX (US)

(73) Assignee: TEXAS INSTRUMENTS INCORPORATED, Dallas, TX (US)

(21) Appl. No.: 14/108,343

(22) Filed: Dec. 17, 2013

Related U.S. Application Data
(60) Provisional application No. 61/738,237, filed on Dec. 17, 2012.

(51) Int. Cl. H04B 1/04

(52) U.S. Cl. CPC H04B 1/0475
USPC 375/296

(57) ABSTRACT

Systems and methods for crest factor reduction (CFR) are described. A multi-band CFR architecture achieves significant hardware savings without sacrificing CFR performance by applying peak cancellation to each band individually. However, peak detection is calculated based on a combined input signal.

### CROSS-REFERENCE TO RELATED APPLICATIONS

The present application claims the benefit of the filing date of U.S. provisional patent application No. 61/738,237 filed Dec. 17, 2012, the disclosure of which is hereby incorporated herein by reference in its entirety.

### BACKGROUND

Fragmented telecom spectrums and the sheer number of frequency bands and sub-bands to be supported worldwide pose a significant challenge for wireless original equipment manufacturers (OEMs). Traditionally, base-station designers have used separate transceiver solutions for each wireless infrastructure standard and frequency band. This leads to a large number of product variants and increased development costs. To reduce costs and simplify deployment, dual- or multi-band transmitter solutions have been considered. These solutions attempt to share as much hardware (e.g., antennas, diplexers, power amplifiers, RF-upconversion, etc.) as possible across multiple-bands.

Advances in power amplifier technologies have enabled using a common power amplifier for multiple transmit channels that are separated over wide frequency ranges. For example, a system may be designed to support two bands, with a 20 MHz bandwidth signal in each band where the bands are separated by more than 190 MHz. In order to operate the power amplifier with high efficiency, crest factor reduction (CFR) and digital pre-distorter (DPD) are crucial.

Two different approaches to CFR design are used in existing multi-band systems.

The first approach is two single-band CFR (2×CFR), which applies CFR on each individual band and then combines the bands into a multi-band signal after CFR is applied. The drawback of this approach is up to 3dB Peak to Average signal power Ratio (PAR) re-growth after combining the two bands together, thus negating most of the peak reduction benefits obtained by the CFR operation. The PAR re-growth is greater than 3dB if more than two bands are combined. These PAR levels are not desirable for CFR because they require a large back-off in signal power level at the PA, resulting in a loss of PA efficiency and increased costs.

The second approach is wideband CFR (wideCFR), which applies CFR on the combined multi-band signal. The multi-band signals are first combined and the combined signal goes through a wideband CFR. This approach uses a conventional CFR/DPD solution but because the CFR is applied on the full signal, it has to operate at a very high sampling rate. To cover a multi-band range of 200 MHz, for example, the system will need to run CFR at 300 MHz and run DPD at a 1000 MHz sampling rate - depending on the oversampling rate requirements for the chosen CFR/DPD implementations. This requires additional hardware costs that make this approach non-practical.

### SUMMARY

Embodiments of the invention provide systems and methods for extending the conventional wideband CFR approach to the dual-band case and propose a dual-band CFR architecture that achieves significant hardware savings without sacrificing CFR performance.

To balance implementation cost and peak growth, peak cancellation is applied to each band individually, while peak detection is calculated based on the combined signal. This architecture can be easily expanded to support a system that has more than two bands.

This CFR architecture achieves lower hardware cost without performance degradation. Individual input signals are sampled at much lower rate compared to a combined signal. Accordingly, hardware logic is reduced by running peak cancellation at this lower rate. Hardware costs are further reduced by approximating the peak of the combined signal without actually generating the combined signal. For example, the sum of the input band signal amplitudes may be used as a close approximation when the two bands are widely separated.

In one embodiment, a signal processing circuit may perform a method for reducing a peak to average signal ratio for a signal. A plurality of input signals is received. A combined signal is created from the plurality of input signals. The combined signal is analyzed to identify signal peaks in the combined signal. Magnitude information and fractional signal peak location information may be determined for at least one signal peak. The magnitude information may comprise a power level for the at least one signal peak.

A separate cancellation pulse is determined for each of the input signals. Each cancellation pulse is based upon at least one of the signal peaks. For example, each cancellation pulse may be based at least in part on the associated input signal, the magnitude information, and the signal peak location information. Each cancellation pulse is applied to an associated input signal. These steps may be repeated a predetermined number of times to reduce a plurality of signal peaks in each of the at least two input signals.

When determining the cancellation pulse for each of the input signals, a different noise level may be allocated on each input signal. The noise level allocated to a selected input signal may be based upon a protocol used in the selected input signal.

A different crest factor reduction method may be applied to each input signal. The crest factor reduction method applied to a selected input signal may be based upon a protocol used in the selected input signal.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### BRIEF DESCRIPTION OF THE DRAWINGS

Having thus described the invention(s) in general terms, reference will now be made to the accompanying drawings, wherein:

FIG. 1 is a block diagram of a typical signal processing system for processing a communication signal.

FIG. 2 is a block diagram of an example crest factor reduction implementation.

FIG. 3 illustrates a new CFR architecture for multi-band systems.

FIG. 4 is a flowchart illustrating a method for reducing a peak to average signal ratio for a signal.

### DETAILED DESCRIPTION

The invention(s) now will be described more fully hereinafter with reference to the accompanying drawings. The invention(s) may, however, be embodied in many different forms and should not be construed as limited to the embodiments set forth herein. Rather, these embodiments are provided so that this disclosure will be thorough and complete, and will fully convey the scope of the invention(s) to a person of ordinary skill in the art. A person of ordinary skill in the art may be able to use the various embodiments of the invention(s).

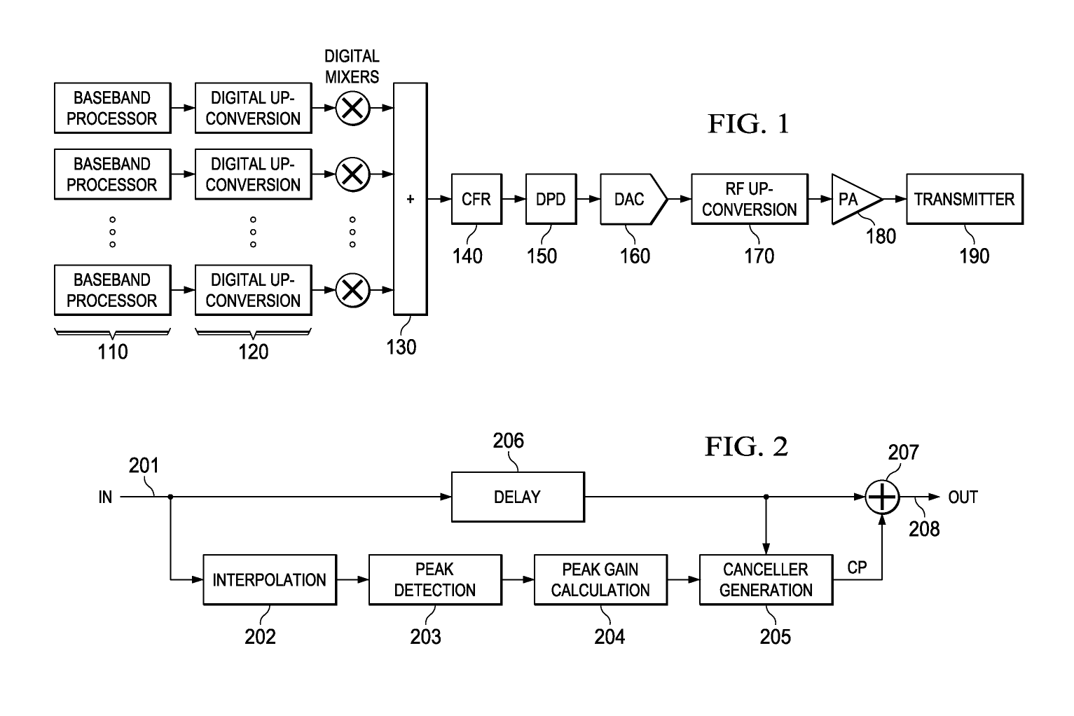

FIG. 1 is a block diagram of a typical signal processing system for processing a communication signal. Each of a plurality of baseband processors 110 create a digital baseband communication signal. Each baseband signal is passed to a digital up-conversion circuit 120 that converts the digital baseband signal into an over-sampled signal. The over-sampled signals are provided to a digital mixer circuit 130 that combines the over-sampled signals into a single composite input signal. The composite input signal is provided to a crest factor reduction circuit 140 that reduces some of the signal peaks relative to the average power of the input signal.

The output of the crest factor reduction circuit 140 is provided to a digital pre-distortion circuit 150. The digital pre-distortion circuit 150 conditions the signal to increase the transmission efficiency of the signal. The digital pre-distorted signal is provided to a digital to analog converter circuit 160. The analog signal provided by the digital to analog converter circuit 150 is provided to an RF up-conversion circuit 170 that adjusts the frequency of the analog signal for transmission. The upconverted analog signal is provided to a power amplifier 180 that amplifies the signal for transmission by a transmitter 190. The transmitter 190 may send the communication signal either wirelessly or through a wired connection.

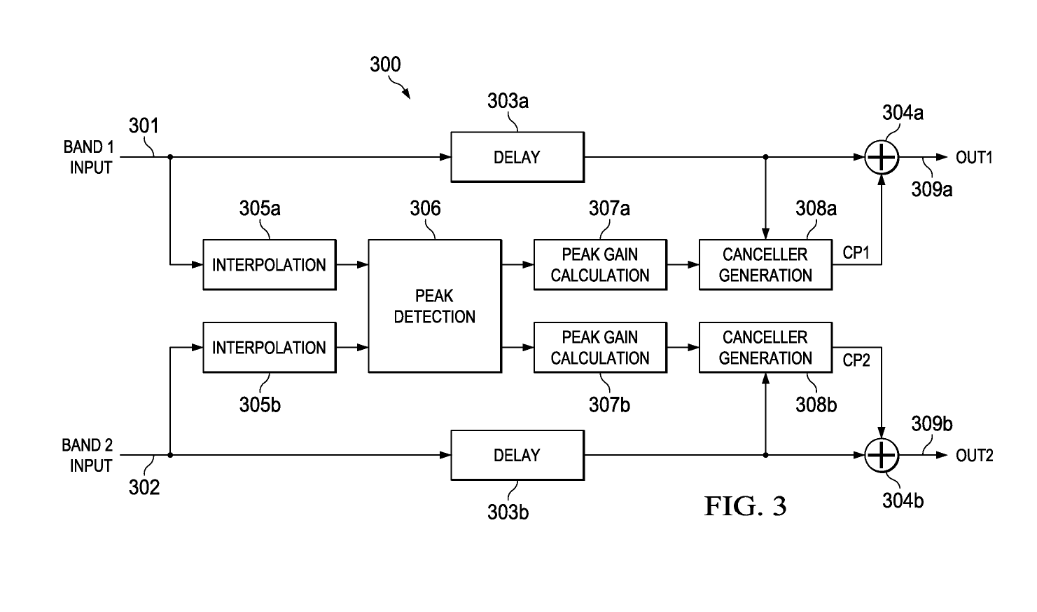

FIG. 2 is a block diagram of an example crest factor reduction implementation. The digital signal to be transmitted is provided at input 201. The input wideband signal is interpolated in block 202. The interpolated signal is provided to peak detection block 203, which identifies peaks in the input signal. The detected peaks are analyzed in peak gain calculation block 204, which determines if the signal peaks will be above a pre-determined clipping level after they pass through digital to analog conversion and RF up-conversion.

Canceller generation block 205 receives the output of the peak gain calculation block 204 and a delayed input signal that has been delayed in delay block 206. Canceller generation block 205 generates a Cancellation Pulse (CP) based on the amplitude and phase of the peak and the pre-determined clipping level. The CP is combined with the delayed input signal in addition circuit 207, where the CP is subtracted from the input signal for peak cancellation to generate output signal 208. Although the CP is shaped to be within spectral mask requirements and meets out-of-band spectral requirements, the CP will still generate in-band distortions, which degrades in-band Error Vector Magnitude (EVM) measurements. The tradeoff between in-band and out-of-band distortions is controlled through a noise shaping filter used for the cancellation pulse generation in block 205.

As noted above, problems arise when the CFR implementation illustrated in FIG. 2 is applied to multi-band input signals. If CFR is applied on each band independently before the bands are combined, then peaks that result from constructive interference in the combined signal will likely be missed and distortion will result when the signal is passed through a power amplifier. If CFR is applied to the combined, wideband signal, peak in the combined signal will likely be detected, but the processing and hardware costs are prohibitive.

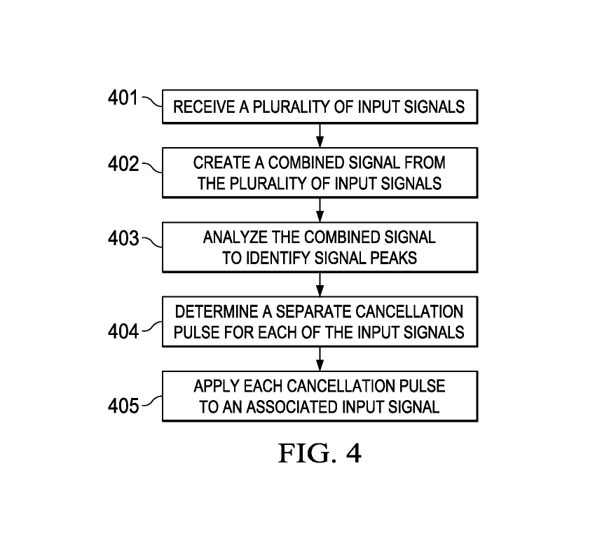

To balance implementation cost and peak detection, a new CFR architecture 300 for multi-band systems is illustrated in FIG. 3. In this multi-band CFR (MBCFR) architecture, peak cancellation is applied to each input band (301, 302) individually, but peak estimation is applied based on the combined signal. Hardware costs may be reduced even further in some embodiments by approximating peaks in the combined signal without actually generating the combined signal. For example, the amplitudes for each input band signal may be summed to estimate the peaks instead of creating the actual combined wideband signal. Alternatively, other signal processing techniques can be used here to approximate the combined signal peak.

As illustrated in FIG. 3, input band 1 (301) and input band 2 (302) flow through separate delay blocks 303a/b and are combined with unique cancellation pulses CP1, CP2 in separate addition circuits 304a/b. To generate the cancellation pulses, the input signals for both bands are processed in separate interpolation blocks 305. The output of both interpolation blocks 305a/b are provided as inputs to peak detection block 306. Peak detection is calculated based upon the combined input signals. The combined signal may be estimated in peak detection block 306 by adding the outputs of blocks 305a/b. In other embodiments, input signals may be combined in other ways at peak detection block 306 as desired by a developer or user to achieve more or less accurate peak detection.

Once the peaks in the combined signal have been detected, the peak detection information is provided to separate peak gain calculation circuits 307a/b for each input band. Peak cancellation is applied to each band individually, while peak detection has been calculated based on the combined signal. The detected peaks are analyzed in peak gain calculation blocks 307a/b, which determine if the signal peaks will be above a pre-determined clipping level for each band.

Canceller generation blocks 308a/b receive the output of the peak gain calculation blocks 307a/b along with their respective delayed input signal from delay blocks 303a/b. Canceller generation block 308a/b generates a CP based on the amplitude and phase of the peak and the clipping level. The CP is combined with the corresponding delayed input signal in addition circuits 304a/b, where the CP is subtracted from the input signal for peak cancellation to generate output signals 309a-b.

The CFR architecture of FIG. 3 provides lower hardware cost without sacrificing CFR performance. Signals from individual bands are sampled at much lower rate compared to the sampling rates that would otherwise be required for a combined, multi-band signal. Hardware logic requirements are reduced by running peak cancellation at this lower rate. Hardware costs may be further reduced by approximating the peak of the combined signal without actually generating the combined signal. For example, the sum of the amplitudes of the individual bands serves as a close approximation of the combined signal when the two bands are separated by a long distance.

The output signals 309a/b may be combined, such as in a digital mixer circuit 130 (FIG. 1). Prior to such combination, the individual output signals 309a/b may be processed by a digital pre-distorter (DPD) circuit 150. Alternatively, the DPD processing may be applied to the wideband signal after the individual output signals 309a/b are combined.

It will be understood that the present invention may be expanded to include more than two input signal bands. Additional input signal bands would be included in the processing by peak detection circuit 306 to identify peaks in the multi-band combined signal.

In FIG. 3, each signal path (305, 306, 307, 308, 303, and 304) may be specially adapted for the particular input band. For example, this architecture allows for dynamically allocating noise on each individual band while using a single power amplifier for the combined signal. As a result, this new approach may achieve the same level of EVM for signal bands with different power levels. In one scenario, the input signal bands have different noise capabilities (e.g., band 1 may be more robust and may tolerate more noise than band 2). The signal path through CFR architecture 300 for the more-robust band 1 may allow for the addition of more noise when adding CP1 compared to the noise added by CP2 in less-robust band 2. Conversely, conventional wideband CFR always splits the noise statically or evenly to all the signal bands.

In addition, CFR architecture 300 allows the system to apply different CFR methods (for example: peak windowing or noise shaping) on different signal bands. This “hybrid approach” allows the system to independently control CFR in each branch. For example, based upon the protocol or technology used in each individual band, CFR architecture 300 may select an optimal CFR method for each band while using a single power amplifier for the combined signal.

In other embodiments, CFR architecture 300 supports the peak placement on fractional sample location to improve performance, which can be crucial when the sampling rate of the full signal is much higher than the sampling rate of individual signal band.

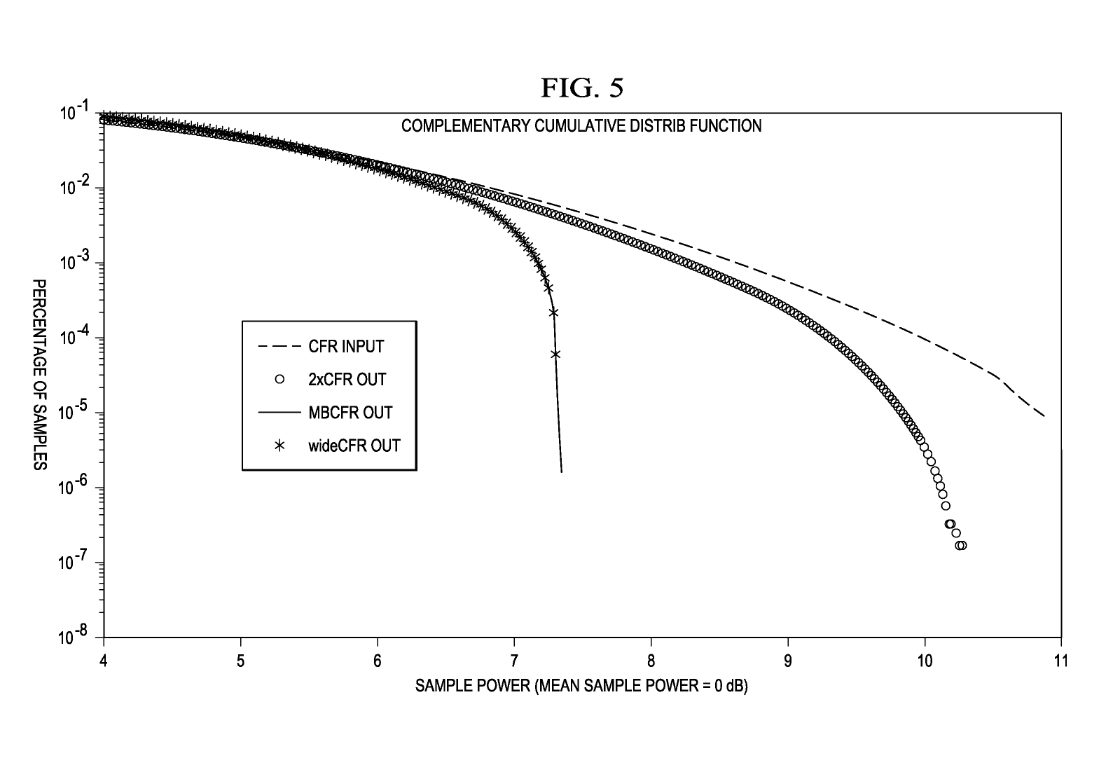

FIG. 4 is a flowchart illustrating a method for reducing a peak to average signal ratio for a signal. In step 401, a plurality of input signals is received. In step 402, a combined signal is created from the plurality of input signals. In step 403, the combined signal is analyzed to identify signal peaks in the combined signal. Magnitude information and fractional signal peak location information may be determined for at least one signal peak. The magnitude information may comprise a power level for the at least one signal peak.

In step 404, a separate cancellation pulse is determined for each of the input signals. Each cancellation pulse is based upon at least one of the signal peaks. For example, each cancellation pulse may be based at least in part on the associated input signal, the magnitude information, and the signal peak location information. In step 405, each cancellation pulse is applied to an associated input signal. These steps may be repeated a predetermined number of times to reduce a plurality of signal peaks in each of the at least two input signals.

When determining the cancellation pulse for each of the input signals, a different noise level may be allocated on each input signal. The noise level allocated to a selected input signal may be based upon a protocol used in the selected input signal. A different crest factor reduction method may be applied to each input signal. The crest factor reduction method applied to a selected input signal may be based upon a protocol used in the selected input signal.

TABLE 1 is a comparison of the different CFR architectures. TABLE 1 lists the complexity of the three approaches (2×CFR, wideCFR, MBCFR) with respect to an example dual-band signal consisting of two 20 MHz signals separated by 190MHz. For MBCFR, hardware costs may be further reduced by approximating the peak of the combined signal without actually generating the combined signal. For example, the sum of the signal power or amplitude may be used to estimate the peak. For the wideCFR solution, both the combined signal generation and signal separation module are part of the transmit chain. Long filters have to be used to achieve low stop-band, which makes wideCFR approach expensive.

TABLE 1

| | MBCFR | 2XCFR | WIDECFR |
|---|---|---|---|
| SAMPLE RATE | 61.44 MHz | 61.44 MHz | 307.2 MHz |
| NOISE SHAPING | 99 taps | 99 taps | 491 taps |
| FILTER | | | |
| EXTRA LOGIC | Multi-band peak | No | Signal combining/ |
| | detection | | separation |
| PERFORMANCE | | 3 dB higher | |
| | | in PAR | |

The performance of the MBCFR algorithm has been demonstrated by experiment as illustrated in the following results. A dual-band signal under test comprised two 10 MHz LTE signals separated by 190 MHz. The lower band was designed to have 3 dB more power than the upper band for the purpose of performance evaluation. An Agilent VSA was used to measure EVM of CFR outputs, which were generated by fixed-point C programs.

FIG. 5 illustrates the complimentary cumulative distribution function (CCDF) curves for different CFR architectures, which confirms that 2×CFR solution has a 3 dB peak penalty.

TABLE 2 illustrates EVM results for different CFR architectures. In general, the MBCFR solution achieves approximately the same level of performance in terms of peak to average ratio (PAR) and EVM as the wideCFR solution but with significant lower hardware cost. In terms of noise distribution, MBCFR results in similar EVM for each signal band while wideCFR leads to similar noise level for each band.

TABLE 2

| | MBCFR | WIDECFR | 2XCFR |
|---|---|---|---|
| LTE1 EVM | 5.3% | 4.5% | 5.3% |
| LTE2 EVM | 4.7% | 6.0% | 1.5% |
| (LTE2 is 3 dB lower | | | |
| in power) | | | |
| PEAK TO AVERAGE | 7.36 dB | 7.33 dB | 10.29 dB |
| RATIO | | | |

It will be understood that in various embodiments, the blocks or modules shown in the figures may represent hardware, sets of software routines, logic functions, and/or data structures that are configured to perform specified operations. Although these modules are shown as distinct logical blocks, in other embodiments at least some of the operations performed by these modules may be combined in to fewer blocks. Conversely, any given one of the modules shown in the figures may be implemented such that its operations are divided among two or more logical blocks. Moreover, although shown with a particular configuration, in other embodiments these various modules may be rearranged in other suitable ways.

Many of the operations described herein may be implemented in hardware, software, and/or firmware, and/or any combination thereof. When implemented in software, code segments perform the necessary tasks or operations. The program or code segments may be stored in a processor-readable, computer-readable, or machine-readable medium. The processor-readable, computer-readable, or machine-readable medium may include any device or medium that can store or transfer information. Examples of such a processor-readable medium include an electronic circuit, a semiconductor memory device, a flash memory, a ROM, an erasable ROM (EROM), a floppy diskette, a compact disk, an optical disk, a hard disk, a fiber optic medium, etc.

Software code segments may be stored in any volatile or non-volatile storage device, such as a hard drive, flash memory, solid state memory, optical disk, CD, DVD, computer program product, or other memory device, that provides tangible computer-readable or machine-readable storage for a processor or a middleware container service. In other embodiments, the memory may be a virtualization of several physical storage devices, wherein the physical storage devices are of the same or different kinds The code segments may be downloaded or transferred from storage to a processor or container via an internal bus, another computer network, such as the Internet or an intranet, or via other wired or wireless networks.

Many modifications and other embodiments of the invention(s) will come to mind to one skilled in the art to which the invention(s) pertain having the benefit of the teachings presented in the foregoing descriptions, and the associated drawings. Therefore, it is to be understood that the invention(s) are not to be limited to the specific embodiments disclosed. Although specific terms are employed herein, they are used in a generic and descriptive sense only and not for purposes of limitation.

1. A method of performing signal processing to reduce a peak to average signal ratio for a signal, the method comprising:
receiving at least two input signals;
analyzing a combined signal generated from the input signals to identify signal peaks in the combined signal;
determining a separate cancellation pulse for each of the input signals, each cancellation pulse based upon at least one of the signal peaks;
applying each cancellation pulse to an associated input signal.

2. The method of claim 1, further comprising:
determining magnitude information for at least one signal peak;
determining fractional signal peak location information for the at least one signal peak;
and wherein each cancellation pulse is based at least in part on the associated input signal, the magnitude information, and the signal peak location information.

3. The method of claim 2, wherein the step of determining magnitude information for the at least one signal peak further comprises determining a power for the at least one signal peak.

4. The method of claim 1 further comprising:
repeating the method a predetermined number of times to reduce a plurality of signal peaks in each of the at least two input signals.

5. The method of claim 1, wherein determining a separate cancellation pulse for each of the input signals further comprises:
allocating a different noise level on each input signal.

6. The method of claim 5, wherein a noise level allocated to a selected input signal is based upon a protocol used in the selected input signal.

7. The method of claim 1, wherein determining a separate cancellation pulse for each of the input signals further comprises:
applying a different crest factor reduction method to each input signal.

8. The method of claim 7, wherein the crest factor reduction method applied to a selected input signal is based upon a protocol used in the selected input signal.

9. A signal processor circuit adapted to provide crest factor reduction (CFR) to at least two input signals, the signal processor circuit comprising:
a peak detection circuit adapted to receive and combine at least two input signals, wherein the peak detection circuit is adapted to identify peaks in the combined signal;
a separate peak gain calculation circuit for each input signal, each peak gain calculation circuit adapted to calculate a power amplifier output signal level for an associated input signal based upon the combined signal peaks identified in the peak detection circuit;
a delay circuit for each input signal, each delay circuit adapted to delay an associated input signal;
a cancellation pulse generator circuit for each input signal, each cancellation pulse generator circuit adapted to create a cancellation pulse based upon an output from an associated peak gain calculation circuit and an output from an associated delay circuit; and
an addition circuit for each input signal, the addition circuit adapted to combine the cancellation pulse and the output from the associated delay circuit to generate an output signal associated with the input signal.

10. The signal processor circuit of claim 9, wherein the peak detection circuit is further adapted to determine magnitude information for at least one signal peak, determine fractional signal peak location information for the at least one signal peak; and
wherein each cancellation pulse is based at least in part on the associated input signal, the magnitude information, and the signal peak location information.

11. The signal processor circuit of claim 10, wherein the magnitude information for the at least one signal peak is determined based upon a power for the at least one signal peak.

12. The signal processor circuit of claim 9, wherein each cancellation pulse generator circuit allocates a different noise level on each of the input signals.

13. The signal processor circuit of claim 9, wherein each cancellation pulse generator circuit applies a crest factor reduction method based upon a protocol used in an associated input signal.

14. The signal processor circuit of claim 9, wherein each cancellation pulse generator circuit applies a different crest factor reduction method to each input signal.

15. The signal processor circuit of claim 14, wherein the crest factor reduction method applied to a selected input signal is based upon a protocol used in the selected input signal.

16. A signal processing circuit for providing crest factor reduction (CFR) to a plurality of input signals, the signal processor circuit comprising:
a single peak detection circuit adapted to receive each of the plurality of input signals and create a combined input signal, the peak detection circuit adapted to identify peaks in the combined input signal; and
a separate CFR signal processing circuit branch associated with each of the plurality of input signals, each CFR signal processing circuit branch adapted to receive an output of the peak detection circuit and a selected one of the plurality of input signals, each CFR signal processing branch circuit adapted to apply a cancellation pulse to the selected input signal in order to minimize distortion caused by the peaks in the combined input signal.

17. The signal processing circuit of claim 16, wherein each CFR signal processing circuit is further adapted to allocate a different noise level for an associated input signal when generating the cancellation pulse.

18. The signal processing circuit of claim 16, wherein the CFR method applied to a selected input signal is based upon a protocol used in the selected input signal.

19. The signal processing circuit of claim 16, wherein each CFR signal processing circuit is further adapted to apply a different crest factor reduction method to each input signal when generating the cancellation pulse.
